(19) United States
(12) Patent Application Publication
(10) Pub. No.: US 2015/0252235 A1
(43) Pub. Date: Sep. 10, 2015

(54) UV-CURABLE SILICONE ADHESIVE COMPOSITIONS

(71) Applicant: 3M INNOVATIVE PROPERTIES COMPANY, St. Paul, MN (US)

(72) Inventors: Joon Chatterjee, Bloomington, MN (US); Hae-Seung Lee, Woodbury, MN (US); Mark D. Purgett, Oakdale, MN (US); Jitendra S. Rathore, Woodbury, MN (US)

(73) Assignee: 3M INNOVATIVE PROPERTIES COMPANY, Sait Paul, MN (US)

(21) Appl. No.: 14/437,028

(22) PCT Filed: Oct. 28, 2013
(86) PCT No.: PCT/US2013/067021

§ 371 Date: Apr. 20, 2015

Related U.S. Application Data
(60) Provisional application No. 61/723,818, filed on Nov. 8, 2012.

(51) Int. Cl. C09J 183/04

(52) U.S. Cl. CPC C09J 183/04

(57) ABSTRACT

A curable composition comprising a silicone, a halomethyl-1,3,5-triazine and optionally a silicate tackifier is disclosed. The compositions are useful in the preparation of pressure-sensitive adhesives and release coatings.

This disclosure relates to a curable silicone composition for preparing release layers and pressure sensitive adhesives, and to substrates bearing a layer of the cured composition. More specifically, this invention relates to a silicone composition, curable with actinic radiation.

### BACKGROUND

As release coating, silicone compositions have been used to render adhesive materials nonadherent to substrates. Such silicone compositions generally comprise a mixture of an ethylenically-unsaturated organopolysiloxane, an organohydrogenpolysiloxane, and a catalyst for the curing of the mixture by means of a hydrosilation reaction.

For example U.S. Pat. No. 4,609,574 discloses a curable silicone coating composition that cures more rapidly at elevated temperatures or cures less rapidly at lower temperatures. This composition comprises (A) a polydiorganosiloxane wherein 90 to 99.5% of all organic groups are methyl and from 0.5 to 10% of all organic groups are selected from vinyl and higher alkenyl groups, (B) an effective amount of a metal hydrosilation catalyst; (C) a methylhydrogenpolysiloxane crosslinking agent compatible with (A) and having an average of at least three silicon-bonded hydrogen atoms per molecule; and (D) an effective amount of an inhibitor for the metal hydrosilation catalyst; and wherein the composition contains 0.8 to 1.5 silicon-bonded hydrogen atoms for every unsaturated group in the composition.

While silicone compositions that provide coatings having low release and fast curing characteristics are known, silicone compositions that provide release coatings which do not require catalysts are sought.

As pressure-sensitive adhesives, silicone compositions are known. They have a variety of applications because they can possess one or more of the following properties: high thermal stability; high oxidative stability; permeability to many gases; low surface energy; low index of refraction; low hydrophilicity; dielectric properties; biocompatibility; and adhesive properties. Examples of such pressure sensitive adhesives are disclosed in U.S. Pat. No. 5,461,134 (Leir et al.), U.S. Pat. No. 5,512,650 (Leir et al.), U.S. Pat. No. 5,475,124 (Mazurek et al.), U.S. Pat. No. 5,792,554 (Leir et al.), U.S. Pat. No. 6,355,759 (Sherman et al.) and U.S. Pat. No. 6,458,454(Kreckel).

Although silicone pressure sensitive adhesives are known to adhere to a wide variety of substrates, there is still a need for adhesives and adhesive articles, particularly tapes that provide an effective peel strength and shear strength to such substrates, without the need for a catalysts or other chemical or physical surface treatment of the substrate. Further, the composition may be prepared neat or in a solvent, and applied to a substrate using a solvent or hot-melt coated.

### SUMMARY

The present disclosure provides a curable silicone polymer or oligomer, and a halomethyl 1,3,5-triazine crosslinking agent. The curable compositions provide novel release coating, and when tackified, pressure-sensitive adhesives. The silicones may be non-functional or functional.

In one embodiment, the present invention provides an article that includes a substrate (or backing) and a release coating of the instant composition disposed on the substrate comprising the curable composition. Release coatings can be used in adhesive tape rolls, where the tape is wound upon itself and usage requires unwinding of the tape roll. Such release coatings are typically referred to as LABs. Release coatings can also be used as a “liner” for other adhesive articles such as labels or medical dressing bandages, where the adhesive article is generally supplied as a sheet-like construction, as opposed to a roll construction.

In another embodiment the present disclosure provides an adhesive article that includes a substrate (or a backing) and an adhesive coating disposed on the substrate comprising the tackified curable composition.

The release coatings prepared from the curable compositions of this disclosure are characterized by the “release test” and the “readhesion test” described herein.

The pressure-sensitive adhesives prepared from the curable compositions of this disclosure provide the desired balance of tack, peel adhesion, and shear holding power, and further conform to the Dahlquist criteria, i.e., the modulus of the adhesive at the application temperature, typically room temperature, is less than 3×10⁶ dynes/cm at a frequency of 1 Hz.

As used herein:

“Alkyl” means a linear or branched, cyclic or acylic, saturated monovalent hydrocarbon having from one to about twelve carbon atoms, e.g., methyl, ethyl, 1-propyl, 2-propyl, pentyl, and the like.

“Alkylene” means a linear saturated divalent hydrocarbon having from one to about twelve carbon atoms or a branched saturated divalent hydrocarbon having from three to about twelve carbon atoms, e.g., methylene, ethylene, propylene, 2-methylpropylene, pentylene, hexylene, and the like.

“Alkenyl” means a linear saturated monovalent hydrocarbon having from one to about twelve carbon atoms or a branched unsaturated hydrocarbon having from three to about twelve carbon atoms.

“Aryl” means a monovalent aromatic, such as phenyl, naphthyl and the like.

“Arylene” means a polyvalent, aromatic, such as phenylene, naphthalene, and the like.

The term “hydrocarbyl” means a saturated or unsaturated linear, branched, cyclic, or polycyclic hydrocarbon group. Unless otherwise indicated, the hydrocarbyl groups typically contain up to 30 carbon atoms, often up to 20 carbon atoms, and even more often up to 10 carbon atoms. This term is used to encompass alkyl, alkenyl, alkynyl groups, as well as cyclic groups such as alicyclic and aromatic groups, for example.

### DETAILED DESCRIPTION

The present disclosure provides a curable composition comprising a polysiloxane and a halomethyl-1,3,5-triazine crosslinking agent. The composition, when cured, provides useful release coatings. The disclosure further provides a curable composition comprising a polysiloxane, a halomethyl-1,3,5-triazine crosslinking agent and a tackifier, such as an MQ resin, which when cured, provides pressure-sensitive adhesive compositions. The composition requires no further catalysts or crosslinking agents.

### Silicone

The silicone used in the curable composition may be any non-functional silicone, or any functional silicone that is conventionally classified as condensation curable silicones, an addition-curable (or hydrosilylation curable) silicones, a free radical-cure silicones, or a cationic-curable silicone. General references regarding curable silicone polymers include Kirk-Othmer Encyclopedia of Polymer Science and Engineering, 2^{nd} edition, Wiley-Interscience Pub., 1989, volume 15, pp. 235-243; Comprehensive Organometallic Chemistry, Ed. Geoffrey Wilkinson, Vol. 2, Chapter 9.3, F. O. Stark, J. R. Falender, A. P. Wright, pp. 329-330, Pergamon Press: New York, 1982; Silicones and Industry: A Compendium for Practical Use, Instruction, and Reference, A. Tomanek, Carl Hanser: Wacher-Chemie: Munich, 1993; Siloxane Polymers, S. J. Clarson, Prentice Hall: Englewood Cliffs, N. J., 1993; and Chemistry and Technology of Silicones, W. Noll, Verlag Chemie: Weinheim, 1960.

The silicone materials useful in the present disclosure are poly diorganosiloxanes, i.e., materials comprising a polysiloxane backbone. In some embodiments, the nonfunctionalized silicone materials can be a linear or branched material of the formula:

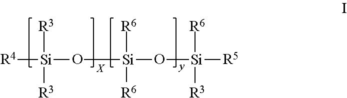

wherein
R³ is each independently an alkyl, aryl or alkoxy group;
R⁴ is H, an alkyl, aryl, alkoxy group, or a functional group including epoxy, amine, hydroxy groups, or —Si(R³)₂R⁵;
R⁵ is H, an alkyl, aryl, alkoxy group, or a functional group including epoxy, amine, hydroxy groups, or —Si(R³)₂R⁵;
R⁶ is H, an alkyl, aryl, alkoxy group, or a functional group including epoxy, amine, hydroxy groups, or —Si(R³)₂R⁵;
y is 0 to 20; preferably 1-75;and
x is at least 10.

In some embodiments, R⁴ and R⁵ is a methyl group, i.e., the nonfunctionalized poly diorganosiloxane material is terminated by trimethylsiloxy groups. In some embodiments, R³ are alkyl groups and y is zero, i.e., the material is a poly(dialkylsiloxane). In some embodiments, the alkyl group is a methyl group, i.e., poly(dimethylsiloxane) (“PDMS”). In some embodiments, one R³ is an alkyl group, and another geminal R³ is an aryl group, and y is zero, i.e., the material is a poly(alkylarylsiloxane), such as poly(methylphenylsiloxane). In some embodiments, R³ are alkyl groups and R⁶ are aryl groups, i.e., the material is a poly(dialkyldiarylsiloxane), such as poly(dimethyldiphenylsiloxane). The nonfunctionalized poly diorganosiloxane materials may be branched. For example, one or more of the R³ and/or R⁶ groups may be a linear or branched siloxane with alkyl or aryl substituents and terminal R⁴ and R⁵ groups.

As used herein, “nonfunctional groups” are either alkyl, alkoxy or aryl groups consisting of carbon, hydrogen. As used herein, a “nonfunctionalized poly diorganosiloxane material” is one in which the R³, R⁴, R⁵ and R⁶ groups are nonfunctional groups.

Functional silicone systems include specific reactive groups attached to the polysiloxane backbone of the starting material (for example, hydride, amino, epoxy or hydroxyl groups). As used herein, a “functionalized poly diorganosiloxane material” is one in which at least one of the R⁷-groups of Formula 2 is a functional group.

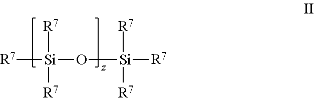

wherein
each R⁷ is independently an alkyl, alkoxy, aryl, or functional groups, with the proviso that at least one R⁷ group is a functional group, and z is at least 10.

In some embodiments, a functional poly diorganosiloxane material in which at least 2 of the functional R⁷ groups are functional groups. Generally, the R⁷ groups of Formula II may be independently selected from the group consisting of a hydride group, an amine group, a hydroxy group, and an epoxy group. In addition to functional R⁷ groups, the remaining R⁷ groups may be nonfunctional groups, e.g., alkyl or aryl groups. In some embodiments, the functionalized poly diorganosiloxane materials may be branched. For example, one or more of the R⁷ groups may be a linear or branched siloxane with functional and/or non-functional substituents.

In some particularly preferred embodiments, the silicone is a functional silicone, wherein at least one of said R⁴ and R⁵ groups of Formula I, or at least one of said R⁷ groups of Formula II, are epoxy, —OH or —NH₂, e.g. epoxy, hydroxy or amine terminated silicones. In particular, poly(dimethylsiloxanes) having hydroxy or amino groups at one or both termini are contemplated:

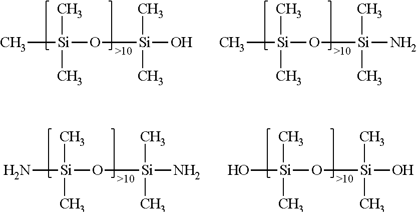

Generally, the silicone materials may be oils, fluids, gums, elastomers, or resins, e.g., friable solid resins. Generally, lower molecular weight, lower viscosity materials are referred to as fluids or oils, while higher molecular weight, higher viscosity materials are referred to as gums; however, there is no sharp distinction between these terms. Elastomers and resins have even higher molecular weights than gums, and typically do not flow. As used herein, the terms “fluid” and “oil” refer to materials having a dynamic viscosity at 25 degrees centigrade of no greater than 1×10⁶ cSt (e.g., less than 6×10⁵ cSt), while materials having a dynamic viscosity at 25 degrees centigrade of greater than 1×10⁶ cSt (e.g., at least 1×10⁷ cSt) are referred to as “gums”. Silicones are generally described in terms of the kinematic viscosity rather than molecular weight or the number of repeat units.

When used in curable compositions to prepare release coating, the preferred silicones have a kinematic viscosity of 1×10⁶ to 20×10⁶ centistokes. When used in curable compositions to prepare pressure-sensitive adhesives, the preferred silicones have a kinematic viscosity of 30,000 to 20×10⁶ centistokes.

The halomethyl-1,3,5-triazine crosslinking agents are found to be highly efficient and reliable UV crosslinkers. They are oxygen tolerant, have scavenging ability, and have been found to cure the instant compositions under low intensity light irradiation. Surprisingly, the cured compositions are stable when exposed to high heat and/or humidity for extended periods. Silicones are known to degrade on exposure to acids, which are a by-product of the crosslinking mechanism with halomethyl-1,3,5-triazines.

Without being bound by theory, it is believed that the halomethyl triazine crosslinking agent functions by hydrogen abstraction of the silicone followed by radical-radical coupling. More particularly, a hydrogen alpha to the silicone atom may be abstracted to form a radical, which may couple with another such radical. Alternatively, the halomethyl-1,3,5-triazine per se may function as a crosslinking agent, whereby a halomethyl radical is generated, which may abstract a proton from the silicone, or couple with a radical on the silicone. The result may be a crosslinked silicone of the general structure:

Silicone —CX₂-Triazine-CX₂-Silicone, where X is halogen as described below.

The halomethyl-1,3,5-triazine is of the general formula:

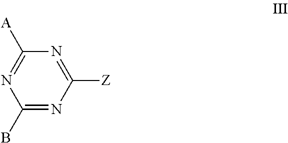

wherein

A is a mono-, di-, or trihalomethyl, preferably trichloromethyl

B is A, —N(R¹)₂, —OR¹, R¹, L-R^{sensitizer} or -L-R^{PI}, where R¹ is H, or preferably alkyl or aryl;

Z is a conjugated chromophore, L-R^{sensitizer} or -L-R^{PI},

L is a covalent bond or a (hetero)hydrocarbyl linking group. Preferably, A and B are trihalomethyl, more preferably trichloromethyl.

In one embodiment, the halomethyl-1,3,5-triazine is as described in U.S. Pat. No. 4,330,590 (Vesley), and is of the formula:

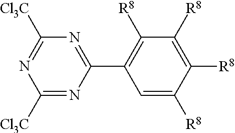

wherein: each R⁸ is independently hydrogen, alkyl, or alkoxy; and 1-3 of the R⁸ groups are hydrogen. Preferably, the alkyl and alkoxy groups have no more than 12 carbon atoms, and often no more than 4 carbon atoms. Preferably, one or two of the meta- and/or para-R⁸ groups are alkoxy, because this tends to provide shorter reaction times. Adjacent alkoxy substituents may be interconnected to form a ring. The triazine component may be prepared by the co-trimerization of an aryl nitrile with trichloroacetonitrile in the presence of HCl gas and a Lewis acid such as AlCl₃, AlBr₃, etc., as described in Bull. Chem. Soc. Japan, Vol. 42, page 2924 (1969).

In another embodiment, the halomethyl-1,3,5-triazine is as described in U.S. Pat. No. 4,329,384 (Vesley), and is of the formula:

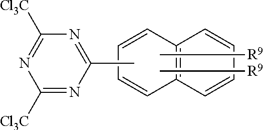

wherein each R⁹ is independently hydrogen, alkyl, or alkoxy. By this representation, it is meant that R⁹ groups can be on either of the fused rings. Preferably, any alkyl or alkoxy group of the photoactive s-triazine component has no more than 12 carbon atoms, and no more than two alkyl and alkoxy groups have more than 6 carbon atoms. In certain embodiments, they have no more than 4 carbon atoms, and the alkyl is often methyl or ethyl, and the alkoxy is often methoxy or ethoxy. Adjacent alkoxy substituents may be interconnected to form a ring. The halomethyl triazine component may be prepared by the co-trimerization of a polynuclear nitrile with trichloroacetonitrile in the presence of HCl gas and a Lewis acid such as AlCl₃, AlBr₃, etc. as described in Bull. Chem. Soc. Jap., Vol. 42, pages 2924-2930 (1969).

Examples of suitable halomethyl-1,3,5-triazines agents include, but are not limited to, 2,4-bis(trichloromethyl)-6-(4-methoxy)phenyl)-s-triazine; 2,4-bis(trichloromethyl)-6-(3,4-dimethoxy)phenyl)-s-triazine; 2,4-bis(trichloromethyl)-6-(3,4,5-trimethoxy)phenyl)-s-triazine; 2,4-bis(trichloromethyl)-6-(2,4-dimethoxy)phenyl)-s-triazine; 2,4-bis(trichloromethyl)-6-(3-methoxy)phenyl)-s-triazine as described in U.S. Pat. No. 4,330,590 (Vesley), and 2,4-bis(trichloromethyl)-6-naphthenyl-s-triazine and 2,4-bis(trichloromethyl)-6-(4-methoxy)naphthenyl-s-triazine as described in U.S. Pat. No. 4,329,384 (Vesley).

In some embodiments the halomethyl-1,3,5-triazine further comprises a photosensistizer group as illustrated in the following formula. Photosensitizers incorporated into the halomethyl-1,3,5-triazines broaden their natural range of sensitivity.

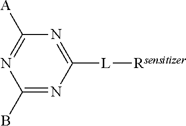

### Wherein

A is a mono-, di-, or trihalomethyl,
B is A, —N(R¹)₂, —OR¹, R¹, L-R^{sensitizer} or -L-R^{PI}, where R¹ is H, or preferably alkyl or aryl;
L is a covalent bond or a (hetero)hydrocarbyl linking group, and
R^{sensitizer} is a sensitizer moiety not being part of the triazine chromophore and being capable of absorbing actinic radiation, preferably said sensitizer moiety having a lambda max of at least 330 nm, and
L represents a hetero)hydrocarbyl group linking the sensitizer moiety to the triazine nucleus, provided that the chromophore of said triazine nucleus is not attached to the chromophore of said sensitizer moiety either directly by a covalent bond or by a conjugated linkage.

The sensitizer group has a lambda max of at least 330 nm, preferably 350 nm up to 900 nm. The presence of the sensitizer moiety gives the compounds of this invention greater spectral sensitivity than halomethyl-1,3,5-triazine compounds not having such a sensitizer moiety. The sensitizer group may be represented by cyanine groups, carbocyanine groups, merocyanine groups, aromatic carbonyl groups, styryl groups, acridine groups, polycyclic aromatic hydrocarbyl groups, polyarylamine groups, amino-substituted chalcone group, and other known to the art. The natural sensitivity of halomethyl-1,3,5-triazines to actinic radiation is well known. Simple derivatives, such as 2-methyl-4,6-bis-trichloromethyl-1,3,5-triazine, absorb actinic radiation in the lower ultraviolet region, e.g. below 300 nm.

More particularly, L represents a (hetero)hydrocarbyl group that links the sensitizer moiety or moieties to the triazine nucleus. The precise identity of L is not critical, but it should be selected so that it does not interfere with or adversely affect the light sensitivity of the compound. Furthermore, L should be chosen so that it does not connect the chromophore of the halomethyl-1,3,5-triazine nucleus and the chromophore of the sensitizer moiety either directly by a covalent bond or by a conjugated linkage. However, any through space intramolecular complexation between the chromophores is not precluded. L can be a single group or can be formed from a combination of groups. Groups that are suitable for linking groups include carbamator (—NHCO₂—), urea (—NHCONH—), amino (—NH—), amido (—CONH₂—), aliphatic e.g., having up to 10 carbon atoms, alkyl, e.g., having up to 10 carbon atoms, alkenyl, e.g., having up to 10 carbon atoms, aryl, e.g., having one ring, styryl, ester (—CO₂—), ether (—O—), and combinations thereof. Based on ease of synthesis, the most preferred groups for attachment directly to the triazine nucleus are carbamato, urea, amino, alkenyl, aryl, and ether. Whenever the group directly attached to the triazine nucleus is either alkenyl group or aryl group, another group must be interposed between the alkenyl group or aryl group and the sensitizer moiety to prevent the sensitizer moiety from forming a conjugate bond with the triazine nucleus.

The following structures exemplify useful -L-R^{sensitizer} groups:

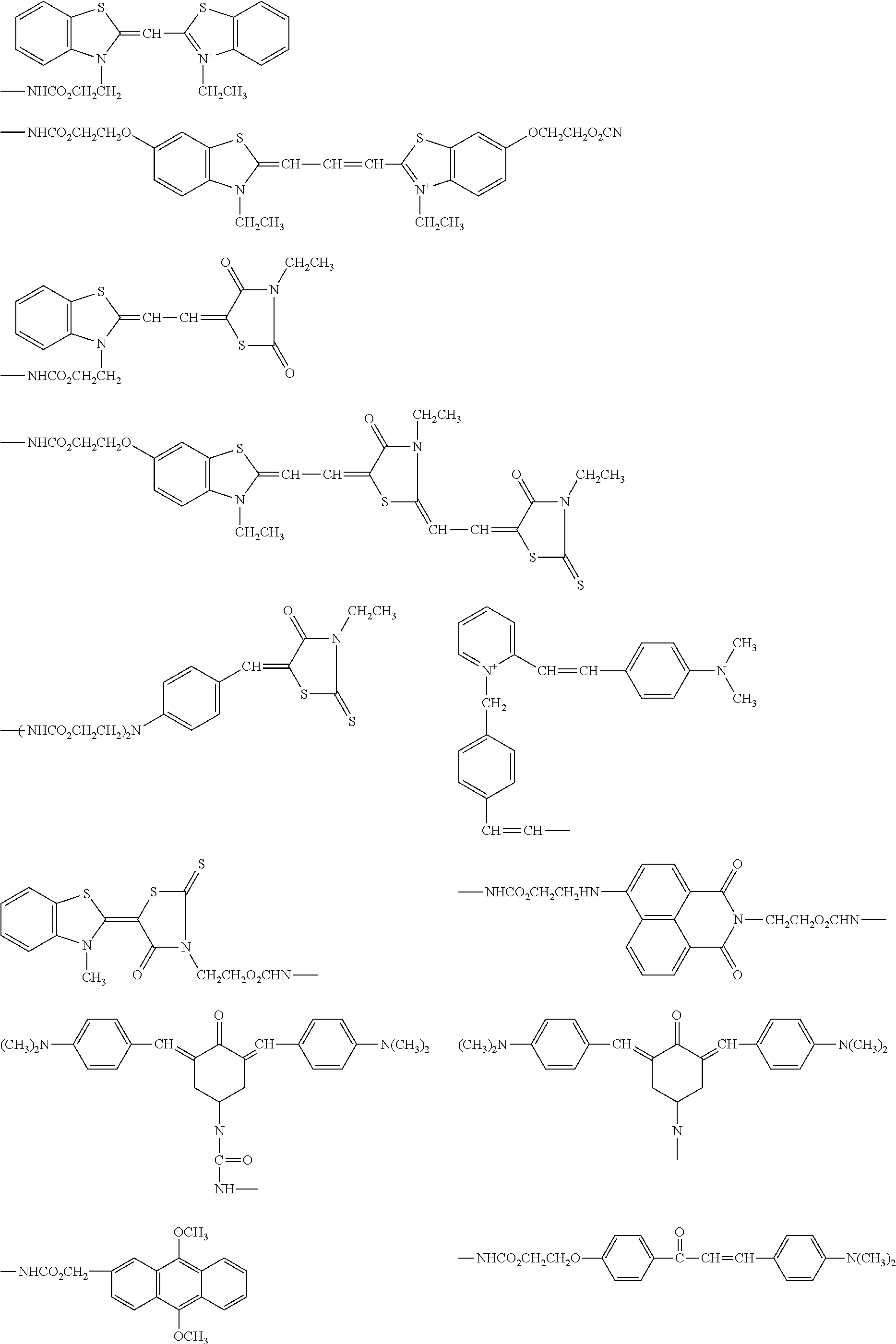

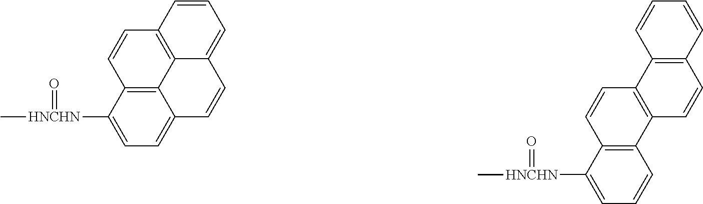

One method of preparing the compounds of this invention is by the addition reaction of isocyanato-substituted halomethyl-1,3,5-triazines with sensitizers having groups reactive with the isocyanate group. The isocyanato substituted triazines may be prepared from the corresponding amino derivative according to the procedure of U. Von Gizycki, Angew, Chem. Int. Ed. Eng., 1971, 10, 403. Isocyanato-1,3,5-triazines suitable for this reaction include: 2,4-bis(trichloromethyl)-6-isocyanato-1,3,5-triazine, 2-isocyanato-4-methyl-6-trichloromethyl-1,3,5-triazine, 2-isocyanato-4-phenyl-6-trichloromethyl-1-3,5-triazine, 2-isocyanato-4-methoxy-6-trichloromethyl-1,3,5-triazine, 2-isocyanato-4-(p-methoxyphenyl)-6-trichloromethyl-1,3,5-triazine, 2-isocyanato-4-(p-methoxystyryl)-6-trichloromethyl-1,3,5-triazine, 2-isocyanato-4-(m,p,-dimethoxyphenyl)-6-trichloromethyl-1,3,5-triazine and 2,4,6-tris(isocyanato)-1-3,5-triazine

Examples of sensitizers that will combine with the isocyanato group include 4-(2′-hydroxyethyl)amino-N-2″-hydroxyethyl)-1,8-naphthalimide, 3,5-bis(dimethylaminobenzal)-4-piperidone, hydroxyethylrhodanine-N″-methylbenzothiazole, 1-aminopyrene, and 6-aminochrysene.

Another method of preparing the compounds of this invention is the co-trimerization of organic nitriles having a sensitizer substituent with haloacetonitriles in accordance with the teachings of Wakabayashi et al, Bulletin of the Chemical Society of Japan, 1969, 42, 2924-30; still another method of preparing the compounds of this invention is the condensation reaction of an aldehyde compound having a photoinitiator functionality in accordance with the teachings of U.S. Pat. No. 3,987,037 (Bonham et al.), incorporated herein by reference. Still another method of preparing the compound of this invention is the nucleophilic displacement reactions on halomethyl-1,3,5-triazines using sensitizers having free hydroxy or amino groups. Further reference to halomethyl-1,3,5-triazines having sensitizer groups may be found in U.S. Pat. No. 5,187,045 (Bonham et al.) incorporated herein by reference.

In some embodiments the halomethyl-1,3,5-triazine further comprises a photoinitiator group —R^{PI} as in the formula:

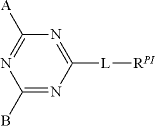

### Wherein

A is a mono-, di-, or trihalomethyl,
B is A, —N(R¹)₂, —OR¹, R¹, or -L-R^{PI}, where R¹ is H, or preferably alkyl or aryl;
L is a covalent bond or a (hetero)hydrocarbyl linking group, and
R^{PI} is a photoinitiator moiety that is capable of initiating free radical or ionic chain polymerization upon exposure to actinic radiation, and, and
L represents a (heterohydocarbyl linking group.

R^{PI} preferably represents at least one group selected from the group consisting of benzoin group, dialkoxyacetophenone group, benzophenone group, anthraquinone group, thioxanthone group, triarylsulfonium group, diaryliodonium group, α-acyloxime group, azide group, diazonium group, 3-ketocoumarin group, bisimidazole group, fluorenone group, or a halomethyl-1,3,5-triazine group covalently bonded to the triazine nucleus of formula I.

L represents a group that links the photoinitiator moiety or moieties to the triazine nucleus. The precise identity of L is not critical, but it should be selected so that it does not interfere with or adversely affect the photoinitation characteristics or light sensitivity of the compound. L can be formed from a single group or it can be formed from a combination of groups. In addition, L also includes a covalent bond. Groups that are suitable for linking groups include carbamato (—NHCO₂—), urea (—NHCONH—), amino (—NH—), amido (—CONH—), aliphatic, e.g., having up to 10 carbon atoms, alkylene, e.g., having up to 10 carbon atoms, haloalkylene, e.g., having up to 10 carbon atoms, alkenyl, e.g., having up to 10 carbon atoms, aryl, e.g., having one ring, styryl, ester (—CO₂—), ether (—O—), and combinations thereof. Based on ease of synthesis, the most preferred groups for attachment directly to the triazine nucleus are carbamato, urea, amino, alkenyl, aryl, and ether. When L represents an alkenyl group, i.e., CH═CHₙ, it is required that the triazine moiety not be ethylenically conjugated with the photoinitiator moiety. Other types of conjugation, e.g., aromatic, carbonyl, are not intended to be excluded by the foregoing requirement.

The following illustrates typical -L-R^{PI} groups:

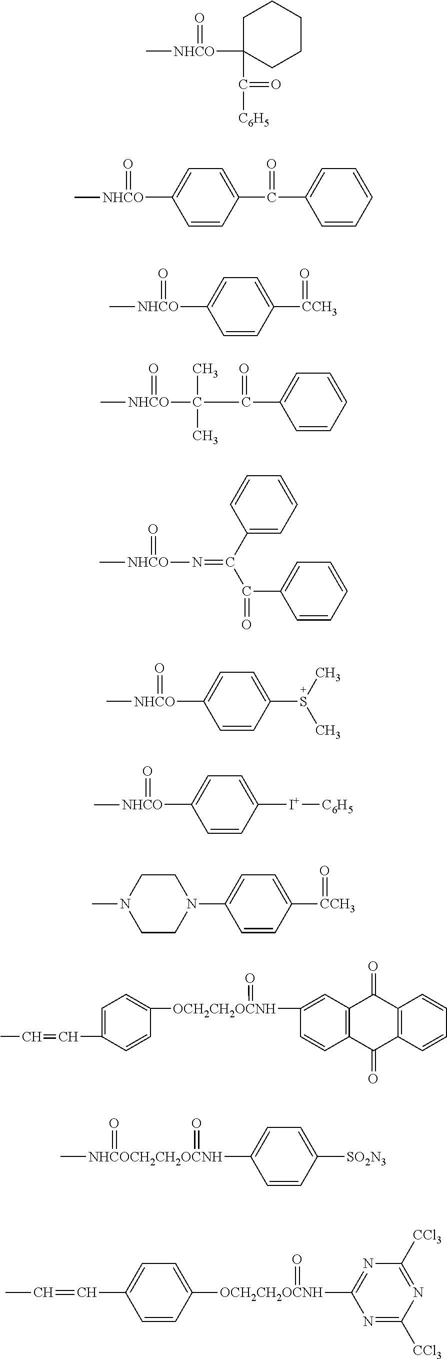

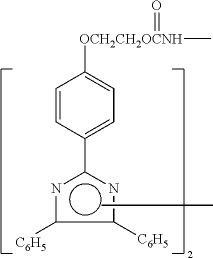

One method of preparing the compounds of this invention is by the addition reaction of isocyanato-substituted halomethyl-1,3,5-triazines with photoinitiators having groups reactive with the isocyanate group, as taught for the sensitizer-substituted triazines supra. Typical photoinitiators that will combine with the isocyanato group include 1-benzoyl cyclohexanol (Irgacureâ 184), 4-hydroxyacetophenone, 4-hydroxybenzophenone, 4-aminobenzophenone, 2-amino-9-fluorenone, 2-aminoanthraquinone, 2-hydroxymethylanthraquinone, 4′-piperidinoacetophenone, 4-hydroxydiphenyliodonium salt, dimethyl-4-hydroxyphenylsulfonium salt, and 2,4-bis(trichloromethyl)-6-hydroxyethylamino-1,3,5-triazine.

Further reference to halomethyl-1,3,5-triazines having photoinitiator groups may be found in U.S. Pat. No. 5,153,323 (Rossman et al.) incorporated herein by reference.

This disclosure provides curable composition, which when cured by the halomethyl-1,3,5-triazine, provide low surface energy release coatings. Useful release coatings have a Release Test Value of less than 200 g/in, preferably less than 100 g/in, per the specified release test method.
In particular, release coating may be prepared from
a) 95 to 99.9 parts by weight silicone, and
b) 0.1 to 5 parts by weight halomethyl-1,3,5-triazine crosslinking agent, the sum being 100 parts by weight. In certain preferred embodiments, the silicone has a dynamic viscosity of 1×10⁶ to 20×10⁶ centistokes and the composition comprises. 98 to 99.5 parts by weight of silicone, and 2 to 0.5 parts by weight of crosslinking agent, the sum being 100 parts by weight.

The present disclosure further provides pressure sensitive adhesive composition that comprises the cured reaction product of a polysiloxane, a halomethyl-1,3,5-triazine and a silicate tackifier resin, known as “MQ resins”.

MQ silicate resins useful in the present adhesive composition include those composed of the structural units M, D, T, Q, and combinations thereof. For example, MQ silicate resins, MQD silicate resins, and MQT silicate resins that also may be referred to as copolymeric silicate resins and that preferably have a number average molecular weight of about 100 to about 50,000, more preferably about 500 to about 10,000 and generally have methyl substituents. Silicate resins include both nonfunctional and functional resins, the functional resins having one or more functionalities including, for example, silicon-bonded hydrogen, silicon-bonded alkenyl, and silanol.

MQ silicone resins are copolymeric silicone resins having R³₃SiO_{1/2} units (M units) and SiO_{4/2} units (Q units), where R³ is an alkyl or aryl group, and most frequently a methyl group.

Such resins are described in, for example, Encyclopedia of Polymer Science and Engineering, vol. 15, John Wiley & Sons, N.Y., 1989, pp. 265 to 270, and U.S. Pat. No. 2,676,182 (Daudt et al.); U.S. Pat. No. 3,627,851 (Brady); U.S. Pat. No. 3,772,247 (Flannigan); and U.S. Pat. No. 5,248,739 (Schmidt et al.), the disclosures of which patents are incorporated herein by reference. MQ silicone resins having functional groups are described in U.S. Pat. No. 4,774,310 (Butler), which describes silyl hydride groups, U.S. Pat. No. 5,262,558 (Kobayashi et al.), which describes vinyl and trifluoropropyl groups, and U.S. Pat. No. 4,707,531 (Shirahata), which describes silyl hydride and vinyl groups, the disclosures of which are incorporated herein. The above-described resins are generally prepared in solvent. Dried or solventless MQ silicone resins are prepared as described in U.S. Pat. No. 5,319,040 (Wengrovius et al.); U.S. Pat. No. 5,302,685 (Tsumura et al.); and U.S. Pat. No. 4,935,484 (Wolfgruber et al.); the disclosures of which are incorporated herein by reference.

MQD silicone resins are terpolymers having R³₃SiO_{1/2} units (M units) and SiO_{4/2} units (Q units) and R³₂SiO_{2/2} units (D units) as described, e.g., in U.S. Pat. No. 5,110,890 (Butler), the disclosure of which is incorporated herein by reference and Japanese Kokai HE 2-36234.

MQT silicone resins are terpolymers having R³₃SiO_{1/2} units (M units), SiO_{4/2} units (Q units), and R³SiO_{3/2} units (T units) such as are taught in U.S. Pat. No. 5,110,890, incorporated herein by reference.

Commercially available silicate resins include SR-545, MQ resin in toluene, available from Momentive Inc., Columbus, Ohio; MQOH resins which are MQ silicate resins in toluene, available from PCR Inc., Gainesville, Fla.; MQR-32-1, MQR-32-2, and MQR-32-3 resins which are MQD resin in toluene, available from Shin-Etsu Chemical Co. Ltd., Torrance, Calif.; and PC-403, hydride functional MQ resin in toluene available from Rhone-Poulenc, Latex and Specialty Polymers, Rock Hill, S.C. Such resins are generally supplied in organic solvent and may be employed in compositions of the present invention as received. However, these organic solutions of silicate resin may also be dried by any number of techniques known in the art, such as spray drying, oven drying, steam drying, etc. to provide a silicate resin at about 100% nonvolatile content for use in compositions of the present invention. Also useful in compositions of the present invention are blends of two or more silicate resins.

In adhesive compositions, the MQ tackifying resin is typically present in the pressure sensitive adhesive composition in an amount sufficient to impart a degree of adhesive tack to the cured composition at the use temperature.

This disclosure provides pressure-sensitive adhesive composition comprising the silicone, the halomethyl-1,3,5-triazine, and the silicate tackifier. More particularly the adhesive comprises the cured reaction product of:
a) 30 to 100 parts by weight silicone
b) 15 to 65 parts by weight silicate tackifier
c) 0.1 to 5 parts by weight halomethyl-1,3,5-triazine crosslinking agent.

The pressure-sensitive adhesives of this disclosure provide the desired balance of tack, peel adhesion, and shear holding power, and further conform to the Dahlquist criteria; i.e. the modulus of the adhesive at the application temperature, typically room temperature, is less than 3×10⁶ dynes/cm at a frequency of 1 Hz.

The composition comprising the silicone, the halomethyl-1,3,5-triazine and optionally the MQ tackifier may be irradiated with activating UV radiation to crosslink the silicone component(s). UV light sources can be of two types: 1) relatively low light intensity sources such as Blacklights which provide generally 10 mW/cm² or less (as measured in accordance with procedures approved by the United States National Institute of Standards and Technology as, for example, with a UVIMAP UM 365 L-S radiometer manufactured by Electronic Instrumentation & Technology, Inc., in Sterling, VA) over a wavelength range of 280 to 400 nanometers; and 2) relatively high light intensity sources such as medium pressure mercury lamps which provide intensities generally greater than 10 mW/cm², preferably 15 to 450 mW/cm². Where actinic radiation is used to fully or partially polymerize the syrup composition, high intensities and short exposure times are preferred. For example, an intensity of 600 mW/cm² and an exposure time of about 1 second may be used successfully. Intensities can range from 0.1 to 150 mW/cm², preferably from 0.5 to 100 mW/cm², and more preferably from 0.5 to 50 mW/cm². Such photoinitiators preferably are present in an amount of from 0.1 to 1.0 part by weight, relative to 100 parts by weight of the total monomer content that would form an unmodified acid-functional (meth)acrylic copolymer.

The crosslinking or curing of the composition may be conducted in the presence of, or preferably in the absence of, suitable solvents such as ethyl acetate, toluene and tetrahydrofuran, which are unreactive with the functional groups of the components of the syrup composition.

It is preferable to coat the composition prior to crosslinking. The composition, either neat or solution, are easily coated upon suitable substrates, such as flexible backing materials, by conventional coating techniques, then further polymerized, and cured, to produce adhesive coated sheet materials. The flexible backing material may be any material conventionally utilized as a tape backing, optical film, or any other flexible material.

The above-described compositions can be coated on a substrate using conventional coating techniques modified as appropriate to the particular substrate. For example, these compositions can be applied to a variety of solid substrates by methods such as roller coating, flow coating, dip coating, spin coating, spray coating knife coating, and die coating. These various methods of coating allow the compositions to be placed on the substrate at variable thicknesses thus allowing a wider range of use of the compositions. Coating thicknesses may vary. The solutions may be of any desirable concentration, and for subsequent coating, but is typically 20 to 70 weight percent (wt-%) polymer solids, and more typically 30 to 50 wt-% solids, in solvent. In some embodiments the compositions may be coated neat. The desired concentration may be achieved by further dilution of the coating composition, or by partial drying.

Adhesive articles and release articles may be prepared by coating the composition on a suitable support, such as a flexible backing. Examples of materials that can be included in the flexible backing include polyolefins such as polyethylene, polypropylene (including isotactic polypropylene), polystyrene, polyester, polyvinyl alcohol, poly(ethylene terephthalate), polybutylene terephthalate), poly(caprolactam), poly(vinylidene fluoride), polylactides, cellulose acetate, and ethyl cellulose and the like. Commercially available backing materials useful in the disclosure include HOSTAPHAN 3SAB, primed polyester film (available from Mitsubishi Polyester Film Inc., Greer, S.C.), kraft paper (available from Monadnock Paper, Inc.); cellophane (available from Flexel Corp.); spun-bond poly(ethylene) and poly(propylene), such as TYVEK and TYPAR (available from DuPont, Inc.); and porous films obtained from poly(ethylene) and poly(propylene), such as TESLIN (available from PPG Industries, Inc.), and CELLGUARD (available from Hoechst-Celanese).

Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metalized polymer films, or ceramic sheet materials may take the form of any article conventionally known to be utilized with pressure-sensitive adhesive compositions such as labels, tapes, signs, covers, marking indicia, and the like.

### EXAMPLES

As used herein all percentages, parts, and ratios are by weight unless otherwise specified. The term adhesive is meant to include a pressure sensitive adhesive.

### Materials

PDMS1—EL Polymer NA, Wacker Chemie AG; Adrian, Mich.
PDMS2—SS4191A 01P silicone gum solution, Momentive; Waterford, N.Y.
PDMS3—XIAMETER® OHX-4070 polymer, Xiameter; Midland, Mich.
MQ resin—MQ resin powder 803 TF, Wacker Chemie AG; Adrian Mich.
Crosslinker—2,4-bis-trichloromethyl-6(4-methoxy-phenyl)-S-triazine
Toluene—OMNISOLV toluene, EMD Chemicals, Billerica Mass.
MEK—methyl ethyl ketone, J. T. Baker; Phillipsburg, N.J.
Backing—HOSTAPHAN 3SAB primed polyester film; Mitsubishi Polyester Film, Inc.; Greer, S.C.
Release liner—Loparex Fluorosilicone release liner, Loparex LLC., Cary N.C.

### Test Methods

### Peel Adhesion Test

The peel adhesion test measures the force required to peel a pressure sensitive adhesive tape from a substrate. Substrates tested were high density polyethylene (HDPE) panels and glass panels. A panel was cleaned by wiping 8-10 times with a tissue wetted with isopropanol using heavy hand pressure, and repeating the procedure twice with clean tissues and solvent. The cleaned panel was allowed to air dry for 30 minutes.

A pressure sensitive adhesive film was stored for at least 3 days in a room with constant temperature (23° C.) and humidity (50% RH) prior to preparing test samples. A test sample was prepared by cutting the adhesive coated film into 1.27 cm×20 cm (½ in.×8 in.) tapes. The tapes were placed on cleaned panels and rolled down with a 2.0 kg (4.5 lb.) rubber roller using 2 passes. Prepared samples were conditioned for 24 hours in a CTH room.

The peel adhesion was measured at a 180° angle on a peel tester (IMASS SP-200 slip/peel tester, IMASS, Inc., Accord Mass.) at a peel rate of 305 mm/minute (12 inches/minute). The peel strength is expressed in ounces/inch (oz/in), and values were the average of two repetitions. The Failure Mode was also noted as “Clean” indicating no adhesive reside was left on the panel, or “Adhesive” indicating that adhesive residue was left on the panel.

### Static Shear Strength Test

The shear strength measures the length of time in minutes that a pressure sensitive adhesive holds a weight in shear mode. A 3.8 cm by 5.0 cm (1.5 inch by 2 inch) stainless steel stainless steel panel was cleaned as described in the Peel Adhesion Test. A pressure sensitive adhesive film was stored in a CTH room for at least 3 days prior to preparing test samples. A 1.27 cm×15.24 cm (½ in.×6 in.) tape was cut from the adhesive coated film, and adhered to the cleaned panel so that the tape overlapped the panel by 1.27 cm×2.54 cm (½ in×1 in.). The tape was rolled down with a 2.0 kg rubber roller using two passes. The free end of the tape was folded over itself on the adhesive side, and folded again. A hook was hung in the second fold and secured by stapling the tape above the hook. A 1 kg weight was attached to the hook and the panel was hung vertically in the CTH room. The time to failure, i.e., when the weight fell off, was recorded in minutes. If no failure occurred after 10,000 minutes, the test was stopped and a value of 10,000+ minutes was recorded. The modes of failure were recorded. A “cohesive” failure was noted if adhesive residue was left on the stainless steel test panel as well as the backing. An “adhesive” failure was noted if the adhesive remained on the backing with no transfer of the adhesive to the test panel.

### Weathering Test at 65° C./75% Relative Humidity

Pressure sensitive adhesive tapes were exposed to elevated temperature and humidity for extended periods of time to evaluate the weathering stability of the tapes. Test samples were prepared with adhesive tapes on cleaned glass panels and conditioned as described in the Peel Adhesion Test. The panels with the tape were then placed in a glass container alongside a beaker with approximately 25 mL of water. The glass container was sealed and placed in an oven set at 65° C. The humidity inside the container was maintained at 75% relative humidity. The amount of water was previously determined to be sufficient to provide the desired humidity for the sealed container. Peel adhesion was measured as described above on panels with no weathering (Initial), and after weathering at 65° C./75% RH for the duration of time indicated in the examples.

### Weathering Test at 65° C./Dry

Pressure sensitive adhesive tapes were exposed to elevated temperatures and essentially dry conditions for extended periods of time. Test samples were prepared as described in the Weathering Test at 65° C./75% Relative Humidity. The samples were then aged in an oven set at 65° C. The atmosphere in the oven was essentially dry. Peel adhesion was measured on the panels with no weathering (Initial) and after weathering at 65° C./Dry for the duration of time indicated in the examples.

### Example 1

A composition was prepared by mixing 5.5 g of PDMS 1, 4.5 g of MQ resin, 0.02 g of crosslinker, 15 g of Toluene, and 15 g of MEK in a sealed glass jar. The composition was mixed on rollers until a clear solution was formed. A tape was prepared by knife coating the solution onto a backing with a gap setting of 20 mils (0.51 mm), and drying in a convection oven set at 70° C. for 15 minutes. The dried adhesive thickness was about 1.4 mils (0.04 mm) The tape was cooled to room temperature and the adhesive side of the tape was exposed to ultraviolet light (UV-B, 600 mJ/cm²) using a UV processor (Fusion UV System, Inc., Gaithersburg, Md.). The tape was tested for 180° Peel Adhesion and Static Shear Strength according to the test methods described above. Test results are shown in Table 1.

### Example 2

A tape for Example 2 was prepared and tested as described in Example 1 except that 0.04 g of crosslinker was used.

### Example 3

A composition was prepared by mixing 10 g of PDMS 1, 10 g of MQ resin, and 0.04 g of crosslinker in a melt mixer (Type Six Mixer, C. W. Brabender Instruments, Inc.; Hackensack, N.J.) at 120° C. for 15 minutes, and then cooled to room temperature. The composition was pressed between a sheet of backing and a release liner in a heated press set at 120° C. to form a linered tape having an adhesive film thickness of about 4.5 mils (0.114 mm) The tape was cooled to room temperature, and then exposed to ultraviolet light (UV-B,) in two passes, first from the backing side, and then from the release liner side with 600 mJ/cm² exposure on each pass. The tape was tested as described in Example 1 and results are shown in Table 1.

### Example 4

A composition was prepared by mixing 5 g of PDMS2, 5 g of MQ resin, 0.02 g of crosslinker, 20 g of toluene, and 20 g of MEK in a glass jar until a clear solution was formed. A tape was prepared by knife coating the solution onto a backing with a gap of 15 mils (0.38 mm) and drying in a convection oven set at 70° C. for 15 minutes. The dried adhesive thickness was about 1.4 mils (0.04 mm) The tape was cooled to room temperature and the adhesive tape was exposed to low intensity ultraviolet light (black light) on both the adhesive side and the backing side simultaneously (600 mJ/cm² on each side). The tape was conditioned and tested as described in Example 1. Results are shown in Table 1.

### Example 5

A tape was prepared and tested as described in Example 3 except that the composition was prepared with 10 g of PDMS3, 10 g of MQ resin, and 0.12 g of crosslinker. The thickness of the film after pressing was about 2.2 mils (0.06 mm) Test results are shown in Table 1.

TABLE 1

180° Peel Adhesion (oz/in)

| | | | | Failure | Static Shear | |
|---|---|---|---|---|---|---|
| Ex | Glass | Failure mode | HDPE | mode | (min) | Failure mode |
| 1 | 29 | clean | 29 | Clean | 190 | Cohesive |
| 2 | 32 | clean | 26 | Clean | 2,400 | Adhesive |
| 3 | 31 | clean | 32 | Clean | 60 | Adhesive |
| 4 | 35 | clean | 24 | Clean | 10,000+ | NA |
| 5 | 33 | clean | 17 | Clean | 20 | Adhesive |

### Examples 6-10

Pressure sensitive adhesive tapes were prepared as described in Example 1. The thickness of the adhesive film after drying was about 1.6 mils (0.04 mm) A release liner was laminated to the dried adhesive surface and the tape was exposed to low intensity UV radiation (blacklight) simultaneously from both the adhesive side and the backing side for the durations of time shown in Table 2. The rate of the dose on each side was 1 mW/cm². The results in Table 2 show that the adhesion to glass remained stable even after extended exposure to UV.

TABLE 2

180° Peel Adhesion - Glass

| Example | UV exposure time | | [oz/in] | Failure mode |
|---|---|---|---|---|
| 6 | 10 | minutes | 25 | Clean |
| 7 | 30 | minutes | 23 | Clean |
| 8 | 1.5 | hours | 23 | Clean |
| 9 | 4 | hours | 23 | Clean |
| 10 | 24 | hours | 24 | Clean |

### Example 11

A composition was prepared by mixing 4 g of PDMS1, 6 g of MQ resin, 0.04 g of crosslinker, 12 g of toluene, and 12 g of MEK in a glass jar until a clear solution was formed. The solution was knife coated onto a backing with a gap of 15 mils and dried in a convection oven set at 70° C. for 15 minutes. The thickness of the dried adhesive coating was about 3.2 mils. After cooling to room temperature, the adhesive coated film was exposed to low intensity ultraviolet light (black light) simultaneously from both the adhesive and film sides with an exposure of 600 mJ/cm² per side.

After curing, a second release liner was laminated onto the exposed adhesive to produce an adhesive transfer tape. The tape was conditioned in a CTH room above for 3 days. The adhesive transfer tape was tested for adhesive properties by removing the second release liner and laminating the adhesive to a backing to produce a single sided tape using a rubber roller laminator at room temperature. When the first release liner was removed from the adhesive for a test sample, there was no adhesive residue left on the liner, indicating good cohesive strength. The tape test sample was conditioned and tested for peel adhesion and shear strength as described above. Peel adhesion on glass was 71 oz/inch with clean peel, and the shear strength was 8300 minutes.

### Example 12

Pressure sensitive adhesive tapes were prepared as described in Example 11 except that the adhesive compositions were coated onto a backing instead of a liner, and the dried adhesive thickness was about 3.0 mils. Tapes were conditioned at CTH and then used to prepare test samples on glass substrates. The test samples were exposed to weathering conditions at 65° C./75% RH according to the test method described above. Peel adhesion from glass was measured for tapes after the durations of exposure shown in Table 3. Results indicate that the peel values remained stable after 8 months of aging under hot and humid conditions.

### Example 13

Pressure sensitive adhesive tapes were prepared and tested as described in Example 12 except that the tapes were weathered at 65° C/Dry according to the test procedure described above. Results in Table 3 indicate that the peel values remained stable after 7 months of aging under hot and dry conditions.

TABLE 3

| | Example 12 | | Example 13 | |
|---|---|---|---|---|
| Duration of | 180° Peel Adhesion - Glass | | 180° Peel Adhesion - Glass | |
| exposure | (oz/in) | Failure mode | (oz/in) | Failure mode |
| Initial | 31.9 | Clean | 58 | Clean |
| 1 Week | nt | nt | 62 | Clean |
| 3 Weeks | nt | nt | 67 | Clean |
| 1 Month | 32.3 | Clean | 64 | Clean |
| 7 Months | nt | nt | 72 | Clean |
| 8 Months | 32.2 | Clean | nt | nt |

nt—not tested

This disclosure provides the following illustrative embodiments:
1. A radiation curable adhesive composition comprising a silicone polymer, an silicate tackifier and a halomethyl-1,3,5-triazine.
2. The adhesive composition of embodiment 1 wherein the composition comprises
   a) 30 to 90 parts by weight silicone
   b) 10 to 70 parts by weight tackifier
   c) 0.1 to 5 parts by weight halomethyl-1,3,5-triazine.
3. The radiation curable composition of any of the previous embodiments wherein the halomethyl-1,3,5-triazine is of the formula:

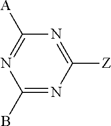

Wherein
A is a mono-, di-, or trihalomethyl,
B is A, —N(R¹)₂, —OR¹, R¹, L-R^{sensitizer} or -L-R^{PI}, where R¹ is alkyl or aryl;
Z is a conjugated chromophore, L-R^{sensitizer} or -L-R^{PI},
L is a covalent bond or a (hetero)hydrocarbyl linking group.
4. The radiation curable composition of embodiment 3 wherein A and B are trichloromethyl.
5. The radiation curable composition of embodiment 3 wherein Z is an aryl group.
6. The radiation curable composition of embodiment 5 wherein Z is

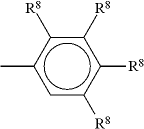

wherein
each R⁸ is independently H, alkyl, or alkoxy and 1-3 of said R⁸ groups are H.
7. The radiation curable composition of embodiment 3 wherein Z is

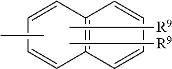

where each R⁹ is independently H, alkyl, or alkoxy.
8. The radiation curable composition of embodiment 3 wherein Z is L-R^{sensitizer}, wherein
   L represents a (hetero)hydrocarbyl group linking the sensitizer moiety to the triazine nucleus, provided that the chromophore of said triazine nucleus is not attached to the chromophore of said R^{sensitizer} sensitizer moiety either directly by a covalent bond or by a conjugated linkage;
   R^{sensitizer} represents a cyanine group, a carbocyanine group, a styryl group, an acridine group, a polycyclic aromatic hydrocarbon group, a polyarylamine group, or an amino-substituted chalcone group.
9. The radiation curable composition of embodiment 3 wherein Z is L-R^{PI}, wherein
   L represents a (hetero)hydrocarbyl group linking the sensitizer moiety to the triazine nucleus,
   R^{PI} represents a hydrogen-abstraction type photoinitiator group.
10. The radiation curable composition of any of the previous embodiments wherein the silicone is of the formula:

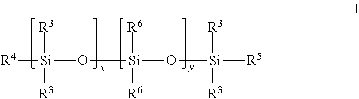

wherein
R³ is each independently an alkyl, aryl or alkoxy group;
R⁴ is H, an alkyl, aryl, alkoxy group, or a functional group including epoxy, amine, hydroxy groups, or —Si(R³)₂R⁵;
R⁵ is H, an alkyl, aryl, alkoxy group, or a functional group including epoxy, amine, hydroxy groups, or —Si(R³)₂R⁵;
R⁶ is H, an alkyl, aryl, alkoxy group, or a functional group including epoxy, amine, hydroxy groups, or —Si(R³)₂R⁵;
y is 0 to 20; preferably 1-75;and
x is at least 10.
11. The radiation curable composition of any of the previous embodiments wherein the silicone is a poly(dialkylsiloxane).
12. The radiation curable composition of any of the previous embodiments wherein the silicone is a hydroxy-terminated poly(dialkylsiloxane).
13. The radiation curable composition of any of the previous embodiments wherein the silicone is an amine-terminated poly(dialkylsiloxane).
14. The radiation curable composition of any of the previous embodiments wherein the silicone has a kinematic viscosity of 30,000 to 20×10⁶ centistokes.
15. The radiation curable composition of embodiment 1, wherein the halomethyl-1,3,5-triazine is of the formula:

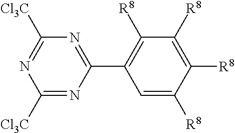

wherein each R⁸ is independently hydrogen, alkyl, or alkoxy; and 1-3 of the R⁸ groups are hydrogen.
16. The radiation curable composition of embodiment 1, wherein the halomethyl-1,3,5-triazine is of the formula:

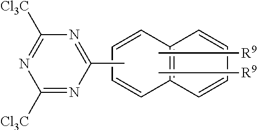

wherein each R⁹ is independently hydrogen, alkyl, or alkoxy.
17. The radiation curable composition of embodiment 8, wherein the halomethyl-1,3,5-triazine is of the formula:

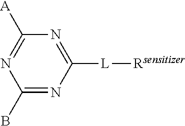

wherein
A is a mono-, di-, or trihalomethyl,
B is A, —N(R¹)₂, —OR¹, R¹, L-R^{sensitizer} or -L-R^{PI}, where R¹ is alkyl or aryl;
L is a covalent bond or a (hetero)hydrocarbyl linking group, and
R^{sensitizer} is a sensitizer group, and
L represents a hetero)hydrocarbyl group linking the sensitizer moiety to the triazine ring.
18. The radiation curable composition of claim 1 wherein the silicone is of the formula:

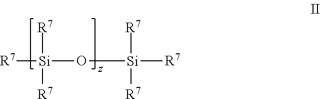

wherein
each R⁷ is independently an alkyl, alkoxy, aryl, or functional groups, with the proviso that at least one R⁷ group is a functional group, and z is at least 10.
19. The radiation curable composition of embodiment 18 wherein at least one of the R⁷ groups are selected from the group consisting of a hydride group, an amine group, a hydroxy group, and an epoxy group and the remaining R⁷ groups are non-functional groups.
20. The radiation curable composition of any of the previous embodiments wherein said silicone is a poly(dialkylsiloxane).
21. The radiation curable composition of embodiment 18 wherein the silicone is selected from:

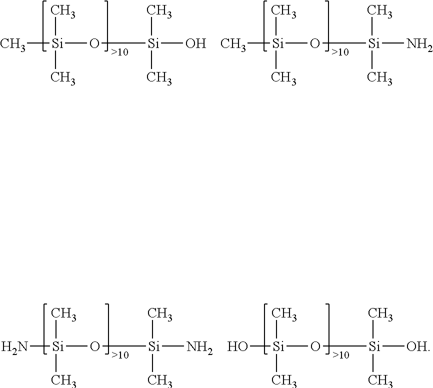

22. A cured adhesive coating comprising the radiation curable composition of any of the previous embodiments on a substrate.
23. The cured adhesive coating of embodiment 22 having a modulus less than 3×10⁶ dynes/cm at a frequency of 1 Hz.

1. A radiation curable adhesive composition comprising
a) 30 to 90 parts by weight silicone polymer
b) 10 to 70 parts by weight silicate tackifier
c) 0.1 to 5 parts by weight halomethyl-1,3,5-triazine.

2. The radiation curable composition of claim 1 wherein the halomethyl-1,3,5-triazine is of the formula: 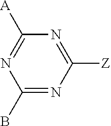
wherein
A is a mono-, di-, or trihalomethyl,
B is A, —N(R¹)₂, —OR¹, R¹, L-R^{sensitizer} or L-R^{PI}, where R¹ is alkyl or aryl;
Z is a conjugated chromophore, L-R^{sensitizer} or L-R^{PI},
L is a covalent bond or a (hetero)hydrocarbyl linking group;
where R^{sensitizer} is a sensitizer moiety capable of absorbing actinic radiation, and
R^{PI} is a photoinitiator moiety that is capable of initiating free radical or ionic chain polymerization upon exposure to actinic radiation.

3. The radiation curable composition of claim 2 wherein A and B are trichloromethyl.

4. The radiation curable composition of claim 2 wherein Z is an aryl group.

5. The radiation curable composition of claim 4 wherein Z is 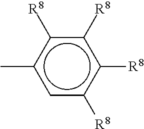
wherein
each R⁸ is independently H, alkyl, or alkoxy and 1-3 of said R⁸ groups are H.

6. The radiation curable composition of claim 2 wherein Z is 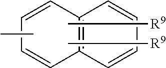
where each R⁹ is independently H, alkyl, or alkoxy.

7. The radiation curable composition of claim 2 wherein Z is L-R^{sensitizer}, wherein
L represents a (hetero)hydrocarbyl group linking the sensitizer moiety to the triazine nucleus, provided that the chromophore of said triazine nucleus is not attached to the chromophore of said R^{sensitizer} sensitizer moiety either directly by a covalent bond or by a conjugated linkage;
R^{sensitizer} represents a cyanine group, a carbocyanine group, a styryl group, an acridine group, a polycyclic aromatic hydrocarbon group, a polyarylamine group, or an amino-substituted chalcone group.

8. The radiation curable composition of claim 2 wherein Z is L-R^{PI}, wherein
L represents a (hetero)hydrocarbyl group linking the sensitizer moiety to the triazine nucleus,
R^{PI} represents a hydrogen-abstraction type photoinitiator group.

9. The radiation curable composition of claim 1 wherein the silicone is of the formula: 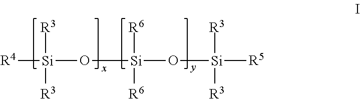
wherein
R³ is each independently an alkyl, aryl or alkoxy group;
R⁴ is H, an alkyl, aryl, alkoxy group, or a functional group including epoxy, amine, hydroxy groups, or —Si(R³)₂R⁵;
R⁵ is H, an alkyl, aryl, alkoxy group, or a functional group including epoxy, amine, hydroxy groups, or —Si(R³)₂R⁵;
R⁶ is H, an alkyl, aryl, alkoxy group, or a functional group including epoxy, amine, hydroxy groups, or —Si(R³)₂R⁵;
y is 0 to 20; preferably 1-75; and
x is at least 10.

10. The radiation curable composition of claim 1 wherein the silicone is a poly(dialkylsiloxane).

11. The radiation curable composition of claim 1 wherein the silicone is a hydroxy-terminated poly(dialkylsiloxane).

12. The radiation curable composition of claim 1 wherein the silicone is an amine-terminated poly(dialkylsiloxane).

13. The radiation curable composition of claim 1 wherein the silicone has a kinematic viscosity of 30,000 to 20×10⁶ centistokes.

14. The radiation curable composition of claim 1, wherein the halomethyl-1,3,5-triazine is of the formula: 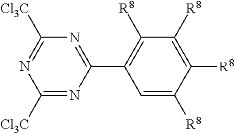
wherein each R⁸ is independently hydrogen, alkyl, or alkoxy; and 1-3 of the R⁸ groups are hydrogen.

15. The radiation curable composition of claim 1, wherein the halomethyl-1,3,5-triazine is of the formula: 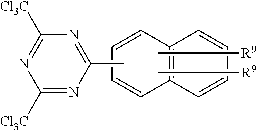
wherein each R⁹ is independently hydrogen, alkyl, or alkoxy.

16. The radiation curable composition of claim 7, wherein the halomethyl-1,3,5-triazine is of the formula: 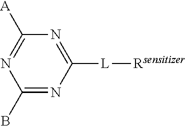
wherein
A is a mono-, di-, or trihalomethyl,
B is A, —N(R¹)₂, —OR¹, R¹, L-R^{sensitizer} or L-R^{PI}, where R¹ is alkyl or aryl;
L is a covalent bond or a (hetero)hydrocarbyl linking group, and
R^{sensitizer} is a sensitizer group, and
L represents a hetero)hydrocarbyl group linking the sensitizer moiety to the triazine ring.

17. The radiation curable composition of claim 1 wherein the silicone is of the formula: 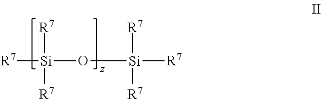
wherein
each R⁷ is independently an alkyl, alkoxy, aryl, or functional groups, with the proviso that at least one R⁷ group is a functional group, and z is at least 10.

18. The radiation curable composition of claim 17 wherein at least one of the R⁷ groups are selected from the group consisting of a hydride group, an amine group, a hydroxy group, and an epoxy group and the remaining R⁷ groups are non-functional groups.

19. The radiation curable composition of claim 1 wherein said silicone is a poly(dialkylsiloxane).

20. The radiation curable composition of claim 17 wherein the silicone is selected from:

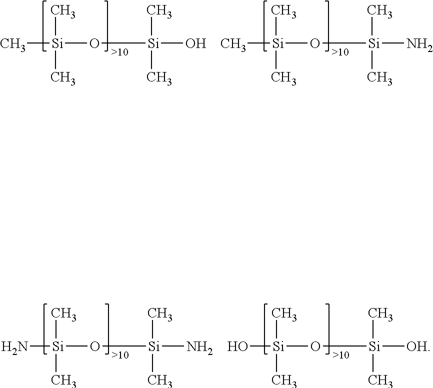

21. A cured adhesive coating comprising the radiation curable composition of claim 1 on a substrate.

22. The cured adhesive coating of claim 21 having a modulus less than 3×10⁶ dynes/cm at a frequency of 1 Hz.
